(19) United States
(12) Patent Application Publication
(10) Pub. No.: US 2018/0034341 A1
(43) Pub. Date: Feb. 1, 2018

(54) SUBMERSED ELECTRIC MOTOR AND METHOD FOR PROVIDING SUCH A SUBMERSED ELECTRIC MOTOR

(71) Applicant: PM S.R.L., Brendola (IT)

(72) Inventor: Paolo PETRUCCI, Montecchio Maggiore (IT)

(73) Assignee: PM S.R.L., Brendola (IT)

(21) Appl. No.: 15/657,431

(22) Filed: Jul. 24, 2017

(30) Foreign Application Priority Data
Jul. 26, 2016 (IT) 102016000078029

(51) Int. Cl. H02K 5/08; H02K 15/14; H02K 15/02; H02K 5/132; H02K 11/00

(52) U.S. Cl. CPC H02K 5/08; H02K 5/132; H02K 11/0094; H02K 15/02; H02K 15/14

(57) ABSTRACT

A submersed electric motor, comprising

a stator assembly arranged within an annular stator chamber,

the annular stator chamber being formed between an outer tubular jacket, an inner tubular jacket which is coaxial to the outer tubular jacket, with two annular end covers adapted to close the annular interspace between the outer jacket and the inner jacket, the annular stator chamber containing solid insulating resin that is adapted to embed the electrical elements contained in the chamber,

a rotor, arranged inside the inner tubular jacket,

an electrical connector, which is adapted for connection to an outlet with an electric power supply cable; the electrical connector comprises electrical terminals for the electrical connection of said stator assembly which are arranged so as to protrude from the solid resin and are surrounded by walls of the same solid resin which form a seat for a power supply outlet, which is open onto a through hole formed in an annular end cover.

The present invention relates to a submersed electric motor.

The invention also relates to a method for providing such a submersed electric motor.

Corresponding submersed electric motors are currently known and used extensively for the actuation of submersed pumps.

One widespread type of submersed motor comprises:

a stator assembly arranged inside an annular chamber, comprising stator windings,
the annular stator chamber is formed between an outer tubular jacket, an inner tubular jacket, which is coaxial to said outer tubular jacket, with two annular end covers which are adapted to close the annular interspace between said outer jacket and inner jacket, said interspace being filled with insulating resin adapted to embed all the electrical elements that are contained in the latter; the resin, in addition to providing electrical insulation, is adapted to facilitate the external transmission of the generated heat and to give strength to the motor in case of deep immersions and therefore high pressures;
a rotor, with a rotation shaft, arranged inside said inner tubular jacket.

The submersed motor normally comprises an electrical plug which is adapted for connection to an external system, i.e., an outlet with a cable, for electric power supply.

Although these motors are widespread and appreciated, they have some aspects that allow improvement, linked to the integration of said plug in one of the two covers of the annular chamber.

Such plug is in fact currently provided by co-molding a plastic connecting part on contact terminals, which are constituted for example by turned metallic elements, and on the corresponding wires soldered thereto.

This plastic connecting part is fixed to a corresponding contoured flange by means of screws, said flange being present to be locked between the outer and inner tubular jackets and a corresponding annular end cover.

The flange then has a seat which is extended in an axial direction, i.e., parallel to the longitudinal axis of the submersed motor, for accommodating the outlet system connected to the power supply cable, the seat having, at its bottom, the plastic connecting part.

The flange is shaped in a particular manner and is therefore expensive.

Furthermore, the electrical connection system as a whole requires a plurality of operations for the assembly of components, which affect the overall cost of the motor.

The aim of the present invention is to provide a submersed electric motor that is capable of obviating the cited limitations of submersed motors of the known type.

Within this aim, an object of the present invention is to provide a submersed motor the electric power supply connection system of which is simpler from the point of view of componentry.

Another object of the present invention is to provide a submersed motor the electrical connection of which has an efficiency and strength that are not lower than those of known submersed motors.

A further object of the present invention is to provide a method for providing a submersed motor according to the aim.

This aim, as well as these and other objects which will become better apparent hereinafter, are achieved by a submersed electric motor according to claim 1 and by a method for providing it according to claim 3.

Further characteristics and advantages of the invention will become better apparent from the description of a preferred but not exclusive embodiment of the submersed electric motor according to the invention, illustrated by way of nonlimiting example in the accompanying drawings, wherein:

FIG. 1 is a sectional side view of a portion of a submersed electric motor according to the invention;

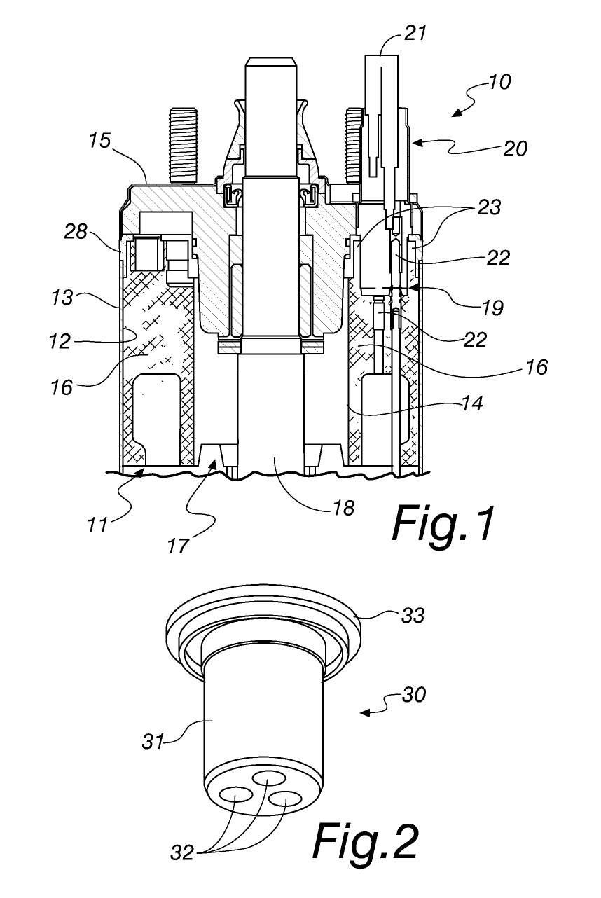

FIG. 2 is a perspective view of a detail for the provision of a motor according to the invention;

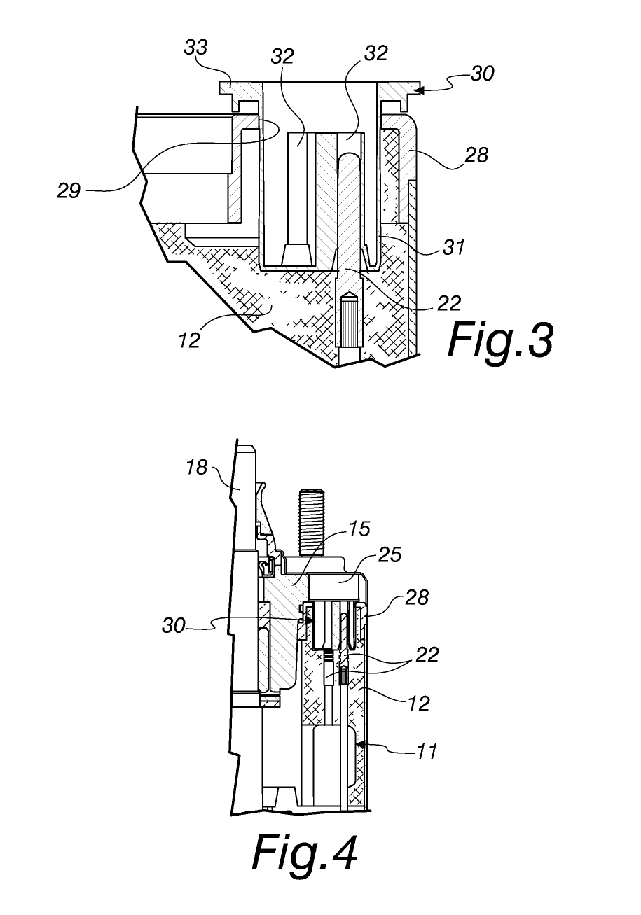

FIG. 3 is a sectional side view of the detail of FIG. 2, inserted in the motor according to the invention;

FIG. 4 is a view of a step of the provision of a motor according to the invention;

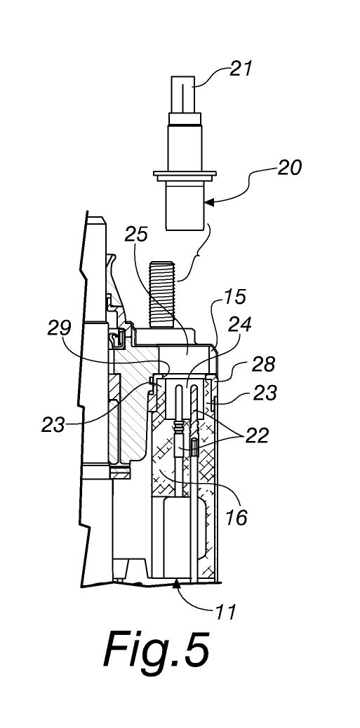

FIG. 5 is a view of another step of the provision of a motor according to the invention.

With reference to the figures, a submersed electric motor according to the invention is designated generally by the reference numeral 10.

The submersed electric motor 10 comprises:
a stator assembly 11 arranged inside an annular stator chamber 12,
the annular stator chamber 12 being formed between an outer tubular jacket 13, an inner tubular jacket 14 which is coaxial to said outer tubular jacket, with two annular end covers, of which one cover 15 is shown in FIG. 1, which are adapted to close the annular interspace between the outer jacket and the inner jacket; the annular stator chamber 12 contains zo solid insulating resin 16 adapted to embed the electrical elements contained in the annular stator chamber 12;
a rotor 17, with a rotation shaft 18, arranged inside the inner tubular jacket 14,
an electrical connector 19, for example a plug, adapted for connection to a outlet 20 with an electric power supply cable 21.

The particularity of the invention resides in that the electrical connector 19 comprises electrical terminals 22 for the electrical connection of the stator assembly 11, which are arranged so as to protrude from the solid resin 16, surrounded by walls 23 of the solid resin 16 which form a seat 24 for a power outlet, which is open onto a through hole 25 formed in an annular end cover 15.

The submersed motor 10 therefore comprises an electrical connector 19, for example a plug, which does not have the plastic connecting part molded onto the contact terminals, its absence eliminating the operations for fixing to a contoured flange in order to accommodate the power supply outlet.

The submersed motor 10 in any case comprises a flange 28 that is locked between the outer tubular jacket 13 and the inner tubular jacket 14, and the corresponding annular end cover 15.

The absence of said plastic part to be fixed allows the provision of a flange 28 that is simpler and therefore cheaper.

The invention also relates to a method for providing such a submersed electric motor.

The provision of a submersed electric motor according to the invention in fact comprises the following steps:

assembling the stator assembly 11 with the corresponding electrical terminals 22 in the annular stator chamber 12 between the inner and outer tubular jackets,
assembling at one end of the annular stator chamber 12 a flange 28 provided with a through hole 29, which has an axial direction, i.e., parallel to the main axis of the motor,
inserting the through hole 29 an insert 30 for the shaping in the solid resin 16 of the 24 for an electrical outlet 20, the insert 30 being contoured to cover and retain in position the terminals 22 and to obstruct the through hole 29,
filling the annular chamber 12 with fluid resin,
upon the solidification of the resin 16, extracting the insert 30, freeing the terminals 22 inside the seat 24.

The insert 30 is clearly visible in FIG. 2; in this constructive exemplary embodiment, which does not limit the invention, the insert 30 is constituted by a cup-like cylindrical body 31 with a number of tubular terminal protection channels 32 that matches the number of electrical terminals 22 to be retained in position and to be protected during the pouring of the resin; the insert 30 is provided with a shoulder 33 for resting on the edge of the through hole 29.

Obviously, the radial dimension of the cup-like body 31 is such as to obstruct the through hole 29 on the flange 28, as clearly visible in FIG. 3.

FIG. 4 is a view of the step of placement of the flange 28 with the insert 30 in the through hole 29 before pouring the resin.

FIG. 5 shows the step of removing the insert 30, freeing the terminals 22 in the seat 24.

In practice it has been found that the invention achieves the intended aim and objects.

In particular, the invention provides a submersed motor the electric power supply connection system of which is simpler from the point of view of components and assembly.

Furthermore, the invention provides a submersed motor the electrical connection of which has an efficiency and strength that are not lower than those of known submersed motors.

Moreover, the invention provides a method for providing such a submersed motor.

The invention thus conceived is susceptible of numerous modifications and variations, all of which are within the scope of the appended claims; all the details may further be replaced with other technically equivalent elements.

In practice, the components and the materials used, so long as they are compatible with the specific use, as well as the contingent shapes and dimensions, may be any according to the requirements and the state of the art.

The disclosures in Italian Patent Application No. 102016000078029 (UA2016A005478) from which this application claims priority are incorporated herein by reference.

What is claimed is:

1. A submersed electric motor, comprising
a stator assembly arranged within an annular stator chamber,
said annular stator chamber being formed between an outer tubular jacket, an inner tubular jacket which is coaxial to said outer tubular jacket, with two annular end covers adapted to close an annular interspace between said outer jacket and said inner jacket, said annular stator chamber containing solid insulating resin that is adapted to embed electrical elements contained in said annular stator chamber,
a rotor, with a rotation shaft, arranged inside said inner tubular jacket,
an electrical connector, which is adapted for connection to an outlet with an electric power supply cable,
wherein said electrical connector comprises electrical terminals for the electrical connection of said stator assembly which are arranged so as to protrude from said solid resin and are surrounded by walls of the same solid resin which form a seat for a power supply outlet, which is open onto a through hole formed in an annular end cover.

2. The submersed motor according to claim 1, further comprising a flange that is locked between the outer tubular jacket and the inner tubular jacket, and the corresponding annular end cover.

3. A method for providing a submersed electric motor according to claim 1, comprising the following steps:
assembling the stator assembly with the corresponding electrical terminals in the annular stator chamber between the inner tubular jacket and the outer tubular jacket,
assembling at one end of the annular stator chamber a flange provided with a through hole, which has an axial direction, i.e., parallel to the main axis of the motor,
inserting in said through hole an insert for shaping in the solid resin of said seat for an electrical outlet, said insert being shaped to cover and retain in position the terminals and obstruct the through hole,
filling said annular stator chamber with fluid resin,
upon the solidification of the resin, extracting said insert, freeing the terminals inside the seat.

4. The method according to claim 2, wherein said insert is constituted by a cylindrical cup-shaped body with a number of tubular terminal protection channels that matches a number of the electrical terminals to be retained in position and to be protected during the pouring of the resin.

5. The method according to claim 3, wherein said insert has a shoulder for resting on the edge of the through hole.

6. The method according to claim 4, wherein a radial dimension of the cup-shaped body is such as to cause an obstruction of the through hole on the flange.
